(19) United States
(12) Patent Application Publication
(10) Pub. No.: US 2018/0107352 A1
(43) Pub. Date: Apr. 19, 2018

(54) Computer-Implemented System And Method For Document Coding Via Coding Patterns

(71) Applicant: FTI Consulting, Inc., Annapolis, MD (US)

(72) Inventors: Joe Milan, Mercer Island, WA (US); David Stromberg, Bellevue, WA (US); John Gayman, Seattle, WA (US)

(21) Appl. No.: 15/783,818

(22) Filed: Oct. 13, 2017

Related U.S. Application Data
(60) Provisional application No. 62/408,728, filed on Oct. 15, 2016.

(51) Int. Cl. G06F 3/0482; G06F 3/0484; G06F 17/30

(52) U.S. Cl. CPC G06F 3/0482; G06F 17/30011; G06F 3/0484

(57) ABSTRACT

A system and method for document coding via coding patterns is provided. Document codes are maintained and coding patterns are identified from the document codes. Each coding pattern includes a grouping of two or more of the document codes. A selection of at least one of the document codes is received for a document. The coding pattern that includes the selected document code is determined. Those document codes associated with the selected document code are identified based on the determined coding pattern. The selected document code and the associated document codes are assigned to the document.

### CROSS-REFERENCE TO RELATED APPLICATION

This non-provisional patent application claims priority under 35 U.S.C. § 119(e) to U.S. Provisional Patent Application Ser. No. 62/408,728, filed Oct. 15, 2016, the disclosure of which is incorporated by reference.

### FIELD

The invention relates in general to document coding and, in particular, to a computer-implemented system and method for document coding via coding patterns.

### BACKGROUND

Currently, the coding of documents can be a time-consuming and extremely expensive process. Further, many inconsistencies can arise during document review, such as between different reviewers and between assigned document codes. Multiple products exist to assist reviewers in reducing the time needed to review documents, such as by grouping documents by concepts. However, those products fail to address the actual assignment of codes to the documents.

To assign document codes, reviewers generally must go through a list of different categories of codes and select one or more code within at least one category. Thus, those documents with multiple codes require multiple selections by the reviewer, which can be time-consuming based on the amount of documents each reviewer must review. Additionally, there are many codes which are used a majority of the time and which the user must select each time for each document.

Accordingly, a need exists for reducing the amount of time spent by a reviewer on assigning classification codes to documents during review. Preferably, multiple codes can be selected at a common time by the reviewer to ensure a reduction of effort and time on behalf of the reviewer.

### SUMMARY

A code assignment webpage includes a concept box, a document list, and a coding box, which includes a conditional coding tree. The conditional coding tree includes coding headings (or questions) and document codes (as answers to the questions). The headings are represented by a first type of symbol, such as asterisks, while the codes are represented by a different type of symbol, such as a selection box that represents options under the heading. Also in the coding box, mini-trees, which are smaller portions of the conditional coding tree, each represent a particular mapping for assigning document codes, such that the mapping follows one or more paths or branches of the conditional tree. Upon selection of a mini-tree, the document codes associated with the mini-tree are assigned to a current document under review. Thus, the mini-trees allow a user to make a one click selection of multiple codes for assigning to a document, rather than individually selecting each code, which reduces a time required for document coding.

An embodiment provides a system and method for document coding via coding patterns. Document codes are maintained and coding patterns are identified from the document codes. Each coding pattern includes a grouping of two or more of the document codes. A selection of at least one of the document codes is received for a document. The coding pattern that includes the selected document code is determined. Those document codes associated with the selected document code are identified based on the determined coding pattern. The selected document code and the associated document codes are assigned to the document.

Still other embodiments of the invention will become readily apparent to those skilled in the art from the following detailed description, wherein are embodiments of the invention by way of illustrating the best mode contemplated for carrying out the invention. As will be realized, the invention is capable of other and different embodiments and its several details are capable of modifications in various obvious respects, all without departing from the spirit and the scope of the invention. Accordingly, the drawings and detailed description are to be regarded as illustrative in nature and not as restrictive.

### BRIEF DESCRIPTION OF THE DRAWINGS

FIG. 1 is a block diagram showing a system for document coding via coding patterns, in accordance with one embodiment.

FIG. 2 is a flow diagram showing a method for document coding via coding patterns, in accordance with one embodiment.

FIG. 3 is a block diagram showing a screenshot of a webpage with a conditional coding tree.

FIG. 4 is a block diagram showing a screenshot of a webpage displaying notice of coding completion.

FIG. 5 is a block diagram showing a screenshot of a webpage for coding the next document of FIG. 4.

FIG. 6 is a block diagram showing a screenshot of a webpage with a provisional coding selection.

FIG. 7 is a block diagram showing a screenshot of a webpage with a final coding selection.

FIG. 8 is a block diagram showing a screenshot of a webpage with a different provisional selection for document coding.

FIG. 9 is a block diagram showing a screenshot of a webpage showing a final coding based on the provisional selection of FIG. 8.

FIG. 10 is a block diagram showing a screenshot of a webpage with a new document selected for coding.

FIG. 11 is a block diagram showing a screenshot of a webpage showing provisional coding based on a selection within the conditional coding tree of FIG. 1.

FIG. 12 is a block diagram showing a screenshot of a webpage showing a final coding based on the provisional coding of FIG. 11.

FIG. 13 is a block diagram showing a screenshot of a webpage showing a further provisional coding for the new document of FIG. 9.

FIG. 14 is a block diagram showing a screenshot of a webpage showing a final coding based on the provisional coding of FIG. 11 and the further provisional coding of FIG. 13.

FIG. 15 is a block diagram showing a screenshot of a webpage with a button for adding a mapping pattern for the final coding of FIG. 14.

FIG. 16 is a block diagram showing a screenshot of a webpage showing the mapped pattern of FIG. 15 with assigned document codings.

FIG. 17 is a block diagram showing a screenshot of a webpage with a conditional list selection button.

FIG. 18 is a block diagram showing a screenshot of a webpage showing a list of document codings based on the conditional tree of FIG. 1.

FIG. 19 is a block diagram showing a screenshot of a webpage showing document coding via the list of FIG. 18.

FIG. 20 is a block diagram showing a screenshot of a webpage showing assignment of codes to a document using the list of FIG. 18.

FIG. 21 is a block diagram showing a screenshot of a webpage displaying a different list of codes for coding documents.

### DETAILED DESCRIPTION

Document coding can be extremely time consuming. Large chunks of time spent by individuals reviewing and coding documents is unnecessarily spent on repetitive actions. For example, documents that are determined to be positively relevant to a legal topic or issue is also responsive. However, utilizing current document coding techniques, a reviewer must separately label the document as relevant and responsive. Additionally, during the review, a reviewer will likely identify many positively relevant documents, which must be individually coded with each of the document codes, which requires time spent by the reviewer. Such time can be reduced by allowing a reviewer to code documents with multiple codes at a single time.

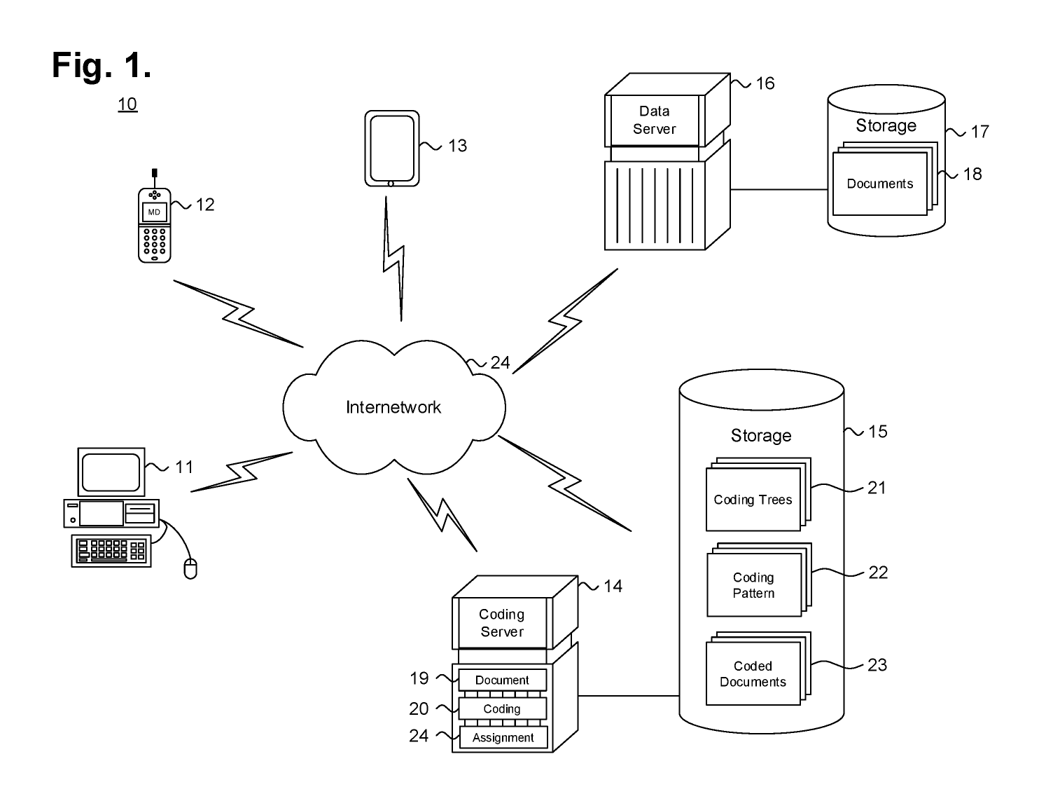

Assigning multiple codes to a document at one time can occur via coding patterns. FIG. 1 is a block diagram showing a system for document coding via coding patterns, in accordance with one embodiment. A reviewer can send a request for a coding web page from a computing device, such as a desktop 11 or laptop (not shown) computer, as well as from a mobile device, such as a cell phone 12 or tablet 13 via an internetwork 24, such as the Internet. A coding server 14 receives the request and provides the web page to the reviewer, which is displayed via the computing device. In a further embodiment, a coding program can be stored on the mobile device and can communicate with the coding server 14.

The coding server 14 includes a document module 19, a coding module 20, and an assignment module 24. The document module 19 accesses a data server 16 to obtain documents 18 for review by the reviewer. The documents 18 can be stored in a database 17 interconnected to the data server 16, which can be maintained by a third party or the same party that maintains the coding server 14. Once obtained, the coding server 14 provides the documents to the reviewer. The coding module 20 can obtain at least one coding tree 21 for providing to the reviewer with one or more coding patterns 22. The coding trees 21 and coding patterns 22 can be generated by the server and stored in a database 15 interconnected to the coding server 14.

The coding tree 21 and coding patterns 22 are provided for display to the reviewer via the mobile device 11-13 with one or more of the documents. For each document, the reviewer can utilize the coding tree 21 and coding patterns 22 to identify at least one of the coding patterns for assignment to that document. Additionally, the assignment module 24 can identify associated document codes for assigning to the document. The assigned document codes are stored in the database 15 with the documents to which they are assigned.

The computing devices and servers can each include one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, as integrated circuitry and each of the client and server can act as a specialized computer. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

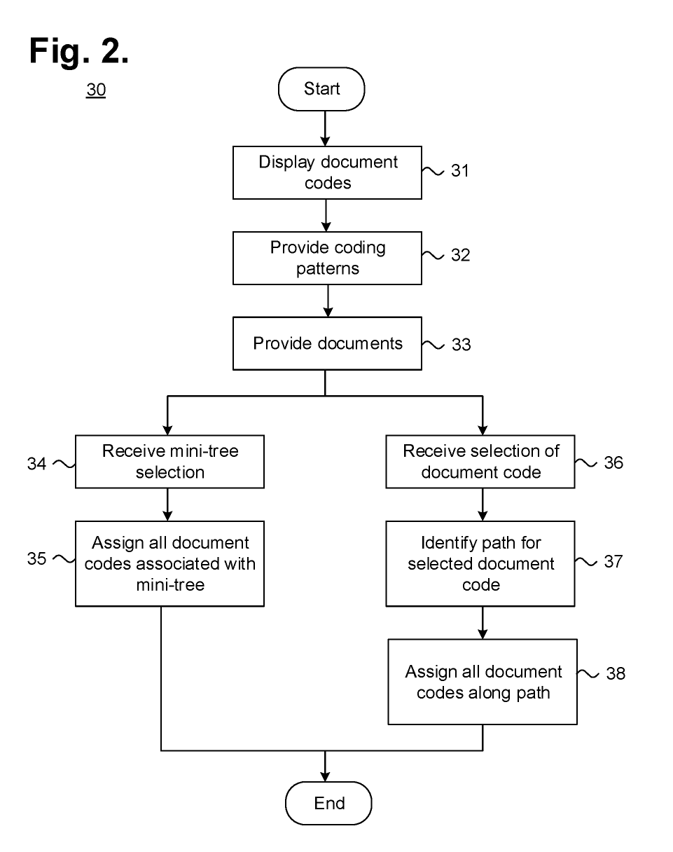

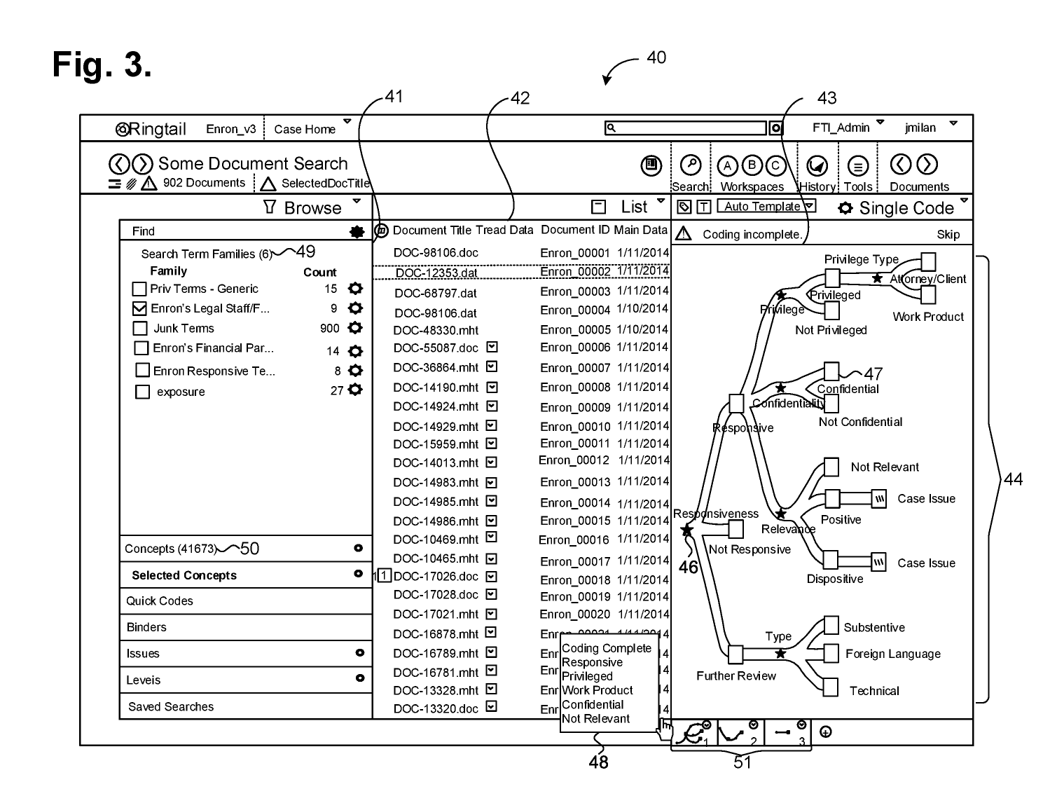

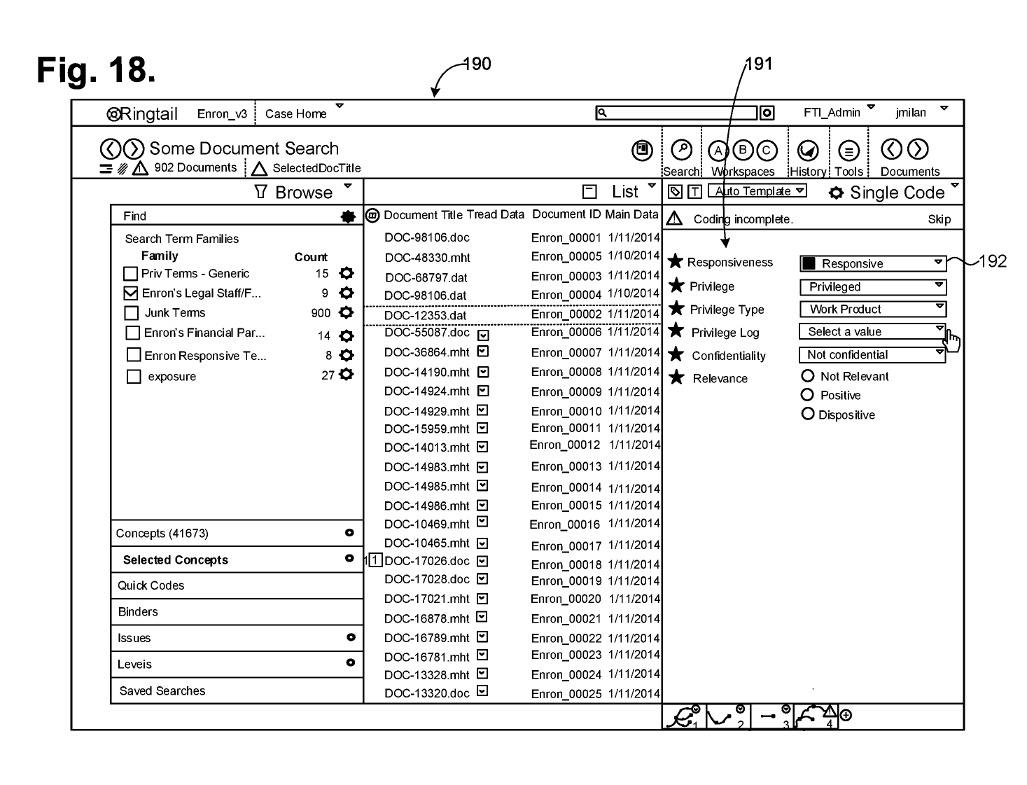

The document codes can be assigned using coding patterns, such as represented by a listing of mini-trees or based on the pathways of the coding tree. FIG. 2 is a flow diagram showing a method 30 for document coding via coding patterns, in accordance with one embodiment. The document codes are displayed (block 31), such as via a coding tree, as described below in further detail with respect to FIG. 3, or via a list format, as described below in further detail with respect to FIG. 18. Coding patterns are also displayed (block 32) such as via mini-trees or as a path within the coding tree. The mini-trees each represent a grouping of document codes based on a partial mapping of the coding tree, whereas the coding tree paths each represent a grouping of document codes that are located on the represented path. Documents are provided (block 33) to the reviewer for review and upon review of the content for one such document, the reviewer can select (block 34) one of the mini-trees from the list. Once selected, the coding patterns associated with the mini-tree are assigned (block 35) to the document. Alternatively, the reviewer can select (block 36) one of the document codes within the coding tree and the path within which the selected document code is located in the coding tree is identified (block 37). Document codes associated with the selected document code are identified as being located along the path and assigned to the document with the selected document code.

Utilizing the coding tree and coding patterns allows the reviewer to assign multiple document codes to a document by only making a single selection, which reduces an amount of time generally required for coding documents when each document code must be individually assigned. FIG. 3 is a block diagram showing a screenshot of a webpage 40 with a coding tree 44. The webpage 40 includes a concept box 41, a document list 42, and the coding box 43, which includes the coding tree 44. In one embodiment, the coding tree can act as a conditional or decision tree. The concept box 41 includes categories 49 of the documents provided in the document list 42 and concepts 50 extracted from the documents. Each category and concept includes a count of the document that are associated with that category or concept. The concept box 41 can also include a search field for identifying one or more concepts associated with the document set. Selecting one of the categories 49 or concepts 50 changes a listing of the documents in the document list 42, such that only those documents that are associated with the selected category or concept are displayed.

The document list 42 includes a list of at least a portion of the document assigned to the reviewer for review and coding. In one embodiment, the documents can be organized or grouped using the categories and concepts provided in the concept box 41. The listing for each document can include a title of the document, thread data, a document identification, and date on which the document was generated or accessed. Other information provided for each document can include individuals that had access to the documents, coding status, and assigned codes, as well as other types of information. Within the document list 42, the reviewer can select at least one of the documents for coding at a time. The selected document can be highlighted within the document list 42 and displayed to the reviewer, such as in a pop up box, a different window, or within a document display section (not shown) that can be included in the webpage 40.

The coding box 43 includes the conditional tree 44, as well as one or more coding patterns 45, which are groupings of document codes. The coding patterns can be represented as predetermined mini-trees or as pathways defined in the tree. The conditional tree 44 includes coding headings 46 and document codes 47. The headings 46 can act as a decision node within the coding tree and cover two or more different document codes. Each heading 46 can be represented by symbols, such as asterisks. Also, each of the document codes 47 can be represented by a symbol, such as a selection box for assigning that code. The document codes 47 can be represented as a terminal node within the tree, or alternatively, a document code acts as a selectable node that further leads to a heading, or decision node. The headings and document codes can be linked via pathways within the coding tree. Each pathway can start at one of the headings and end at one or more of the document codes. For example, when the pathway ends at two or more document codes, the pathway likely includes multiple branches of the coding tree.

In the conditional tree 44, for example, the asterisk representing responsiveness includes codes for responsive, non-responsive, and further review. Additionally, the responsive code leads to coding headings for privilege, confidentiality, and relevance. The privilege heading includes codes for privileged and not privileged. Further, the privileged code leads to a coding heading for privilege type, which includes further codes for attorney/client privilege and work product privilege. The confidentiality heading, under the responsive code covers confidential and non-confidential codes, while the relevance heading includes codes for not relevant, positive, and dispositive. The positive and dispositive codes each include codes for case issue. In one example, when the codes can be condensed in the coding box 44 or hidden to prevent the coding tree from becoming too big for the display. For example, the case issue codes each include three dots in the box, which provides notice that upon selection of the case issue box, the document codes under case issue can be displayed. Finally, the further review code includes a heading for document type, which includes codes for substantive, foreign language, and technical. The conditional tree 41 provides an overview of how all the document codes fit together and is helpful for quality control by maintaining consistency of the codes for assignment, as described below.

The coding patterns 45 can be provided in a coding list 51. The coding list can be loaded with default coding patterns 45 or the reviewer can select those coding patterns 45 for inclusion in the list. In one example, the coding list 51 includes those patterns most frequently used for coding documents under review. Each of the coding patterns 45 represents a mini-tree, which is a partial mapping of the conditional tree 44. In one embodiment, the mini-tree for each coding pattern 45 can be based on one or more layers of document codes. For example, a coding pattern for a privileged document can also include a responsive code.

Upon selection of a coding pattern 45, the document codes associated with the mini-tree are assigned to a current document under review, as further described below with respect to FIG. 2. Thus, the coding patterns 45 allow a reviewer to make a one click selection of multiple codes for assigning to a document, rather than individually selecting each code associated with that coding pattern. In one embodiment, the coding patterns 45 can be generated by a reviewer, supervisor, or administrator for those codes that are commonly assigned to documents and that are relevant to the legal issue or case for which the documents are coded. The coding patterns can be generated prior to the review or during the review.

A pop-up box 48 displayed adjacent to the coding box 13 includes different code types, including responsive, privileged, work product, confidential, and not relevant. A reviewer can click on one of the codes in the pop-up box 48 to identify the documents assigned to that code. Other coding types are possible.

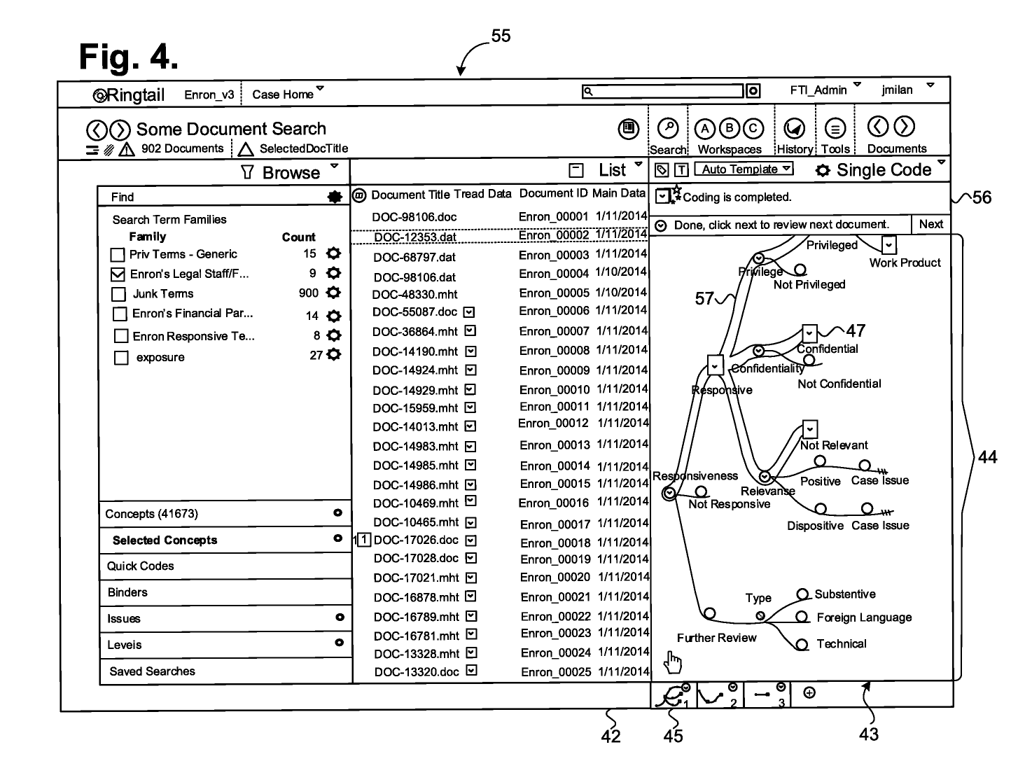

FIG. 4 is a block diagram showing a screenshot of a webpage 55 displaying a selection of a coding pattern. Upon review of a document, the reviewer can select one of the coding patterns 45. Once selected, the coding pattern 45 can be displayed 57 in the coding box 43. The document codes 47 associated with the selected coding pattern 57 include responsive, privileged, work product, confidential, and not relevant. Subsequently, the highlighted document in the document list 42, adjacent to the coding box 43, is assigned with the document codes associated with the selected coding pattern. Once assigned, the reviewer is notified that the coding for that document is completed and the reviewer can select a next button for accessing and reviewing the next document in the list.

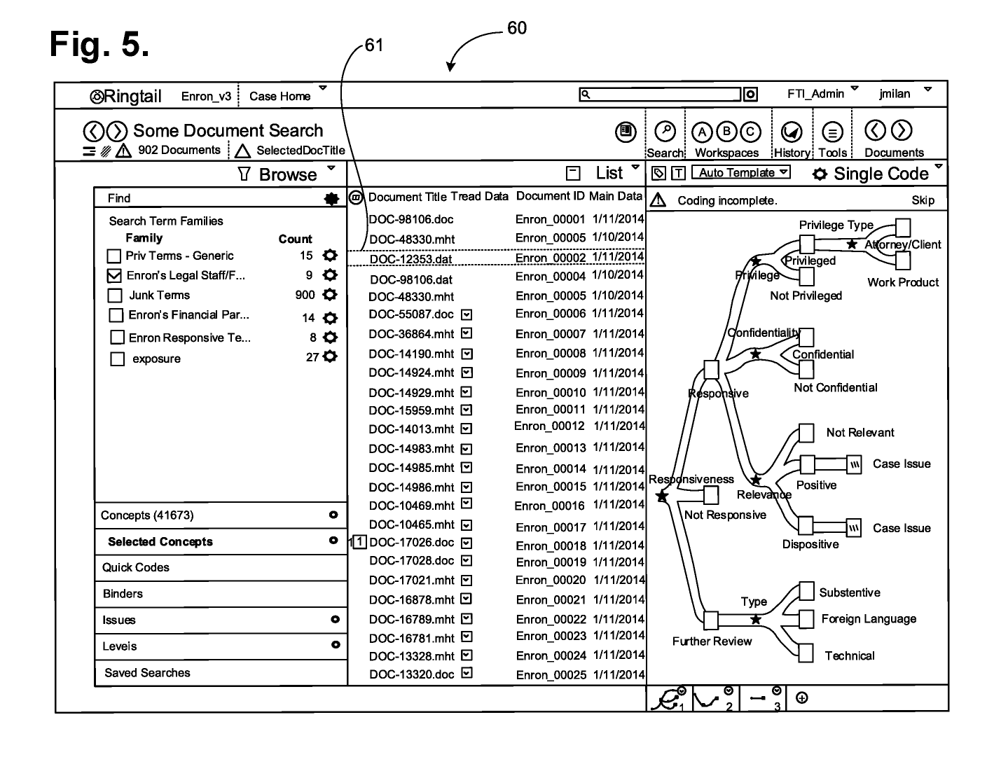

Upon selection of the next button, the next document in the document list is selected and highlighted. FIG. 5 is a block diagram showing a screenshot of a webpage 60 for displaying the next document 61 for coding. Once the next document has been selected, the coding tree is cleared and for coding of the current document.

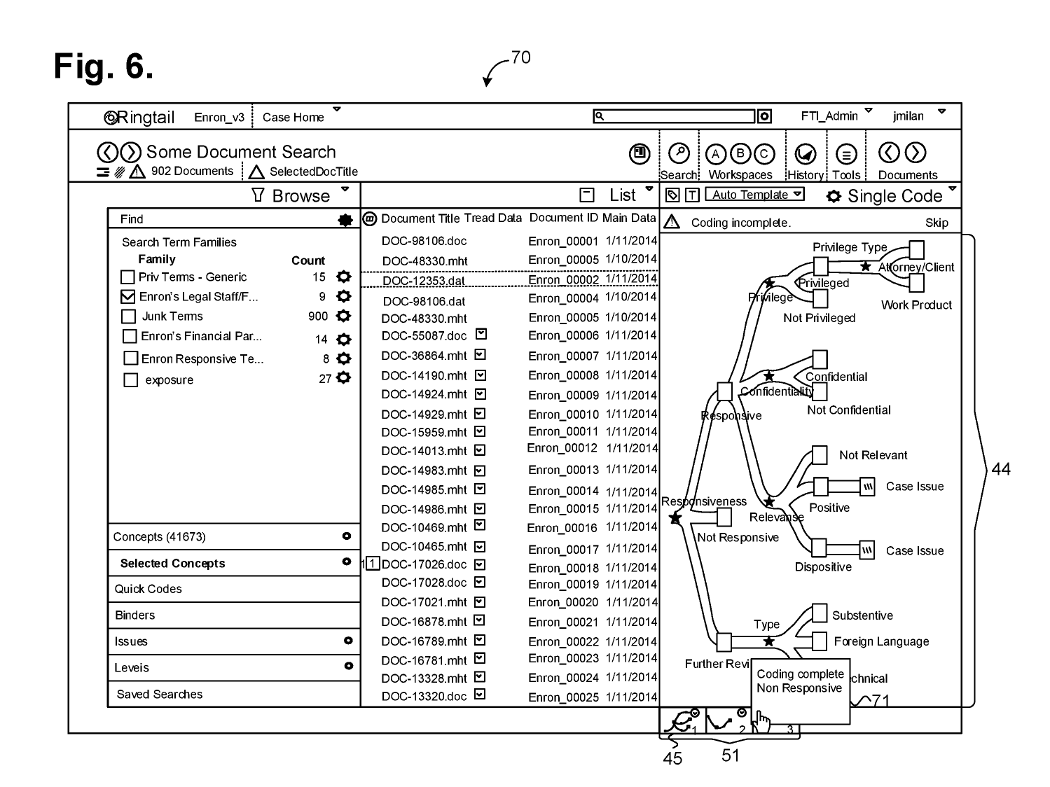

FIG. 6 is a block diagram showing a screenshot of a webpage 70 with a provisional coding selection. During review of a document, the reviewer can hover a cursor or finger over one of the coding patterns and a list 71 of document codes associated with that coding pattern is displayed. In this example, the document code associated with the third coding pattern 45 in the coding list 51 includes a non-responsive code. If the reviewer wishes to assign a non-responsive code to the selected document, the user can select that coding pattern 45.

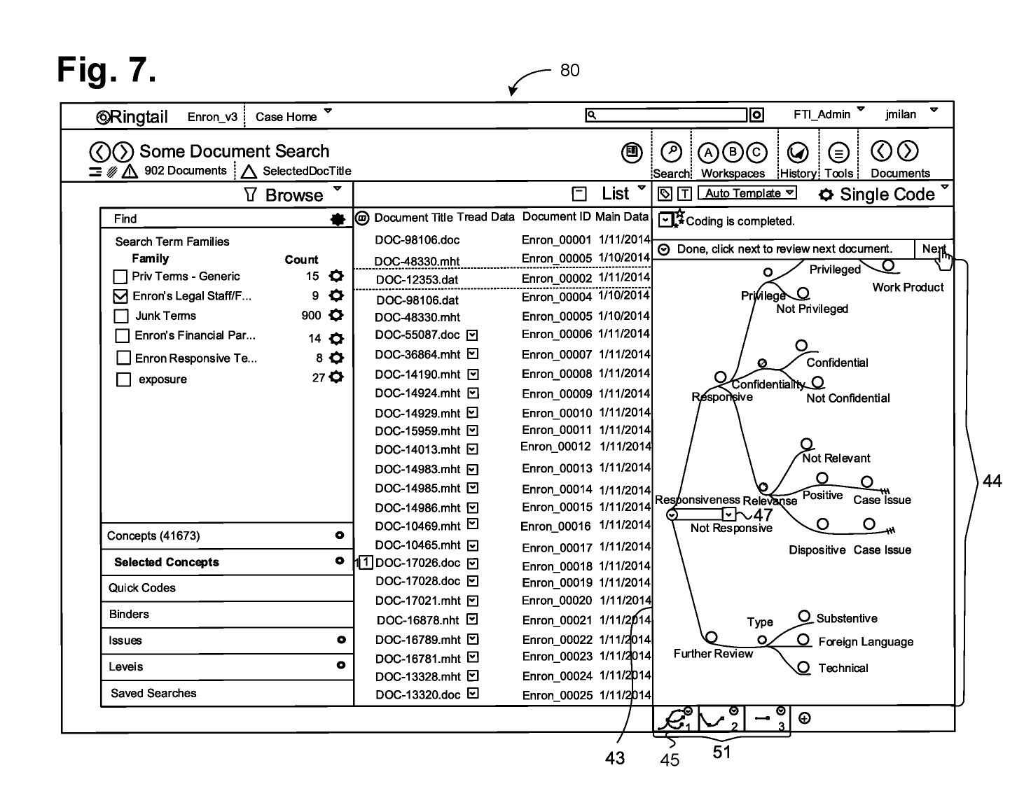

Upon selection, the path represented by the coding pattern is highlighted in the conditional tree 44, the selection boxes for the document codes associated with the coding pattern are checked, and the checked codes are assigned to the highlighted document in the document list. FIG. 7 is a block diagram showing a screenshot of a webpage 80 with a final coding selection. The pattern of the third coding pattern 45 in the coding list 51 is highlighted in the conditional tree 44 and the selectable box for the associated document code, non-responsive, is checked.

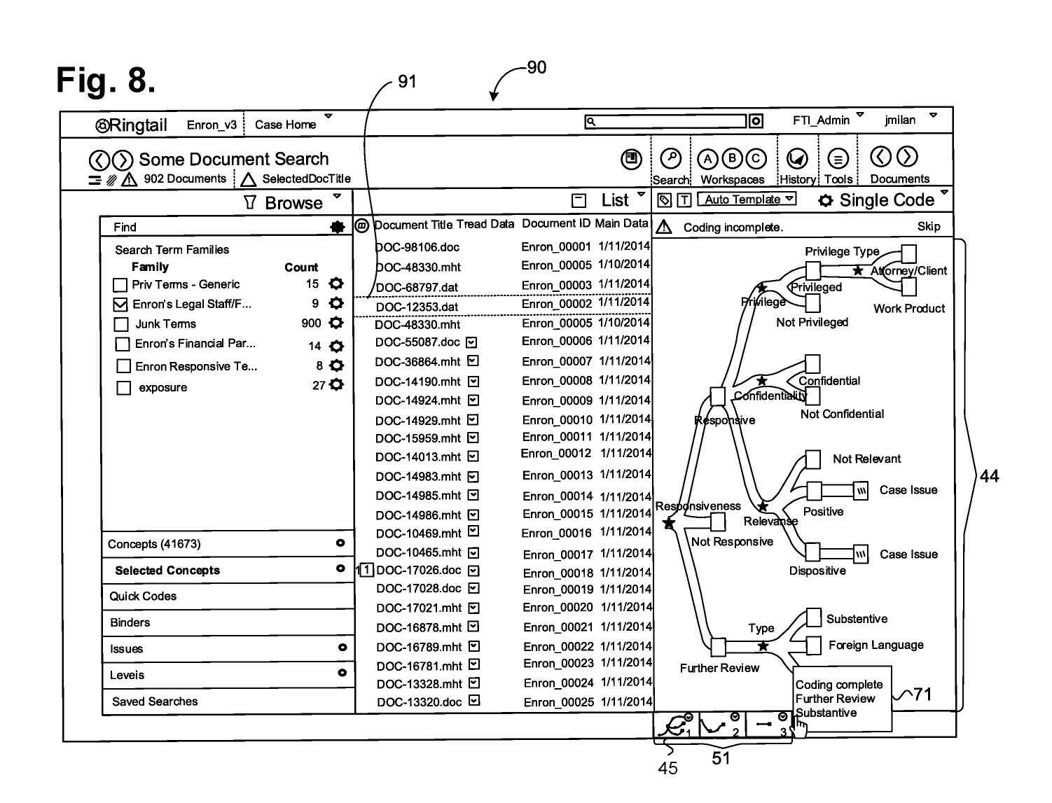

Once a document is coded, a new document can be selected. FIG. 8 is a block diagram showing a screenshot of a webpage 90 with a different provisional selection for document coding. The next document 91 is highlighted and displayed to the reviewer. After review of the new document, the reviewer determines that the documents should be further reviewed due to substantive issues. The reviewer can hover a cursor over the coding patterns 45 in the coding list 51 to identify a coding pattern which is associated with codes for further review and substantive. The hovering motion of the cursor prompts a list 71 of codes to appear for the pattern on which the cursor is located.

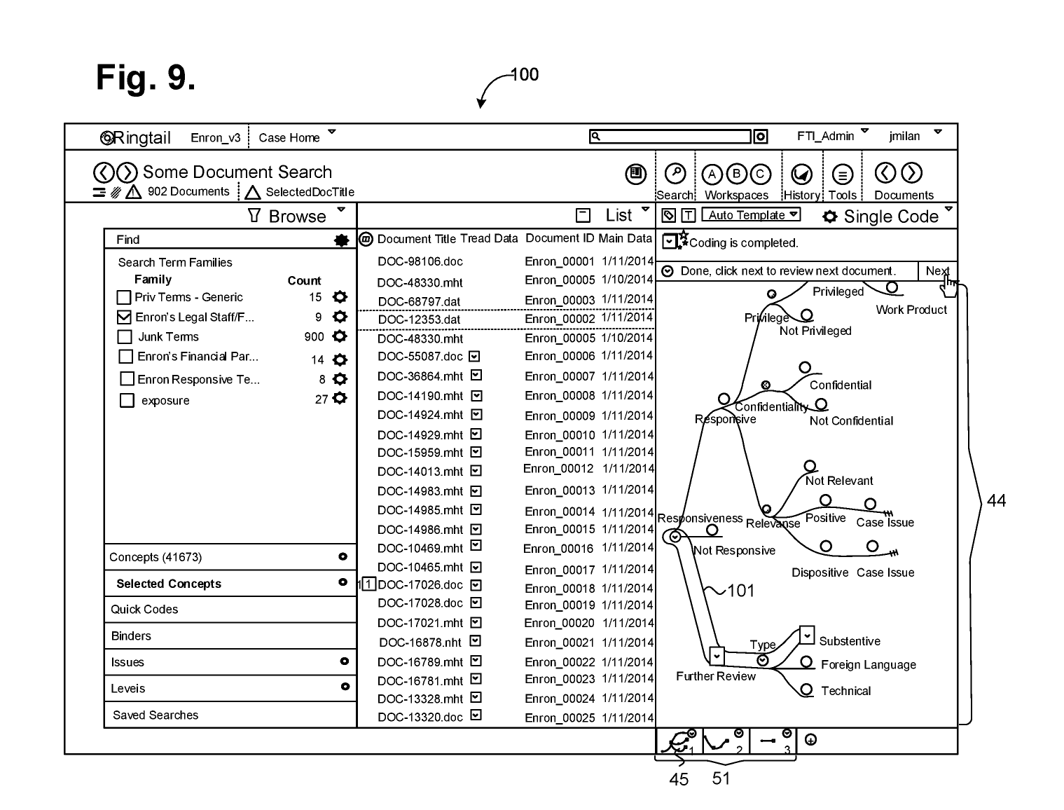

Once identified, the reviewer can select that coding pattern, which is highlighted on the conditional tree 44 and the document codes 47 associated with that pattern are assigned to the highlighted document in the document list. FIG. 9 is a block diagram showing a screenshot of a webpage 100 showing a final coding based on the provisional selection of FIG. 8. The coding pattern selected by the reviewer is highlighted 101 on the conditional tree 44 and the selection boxes for the document codes associated with the selected coding pattern are checked. The document codes with checked selection boxes are assigned to the document.

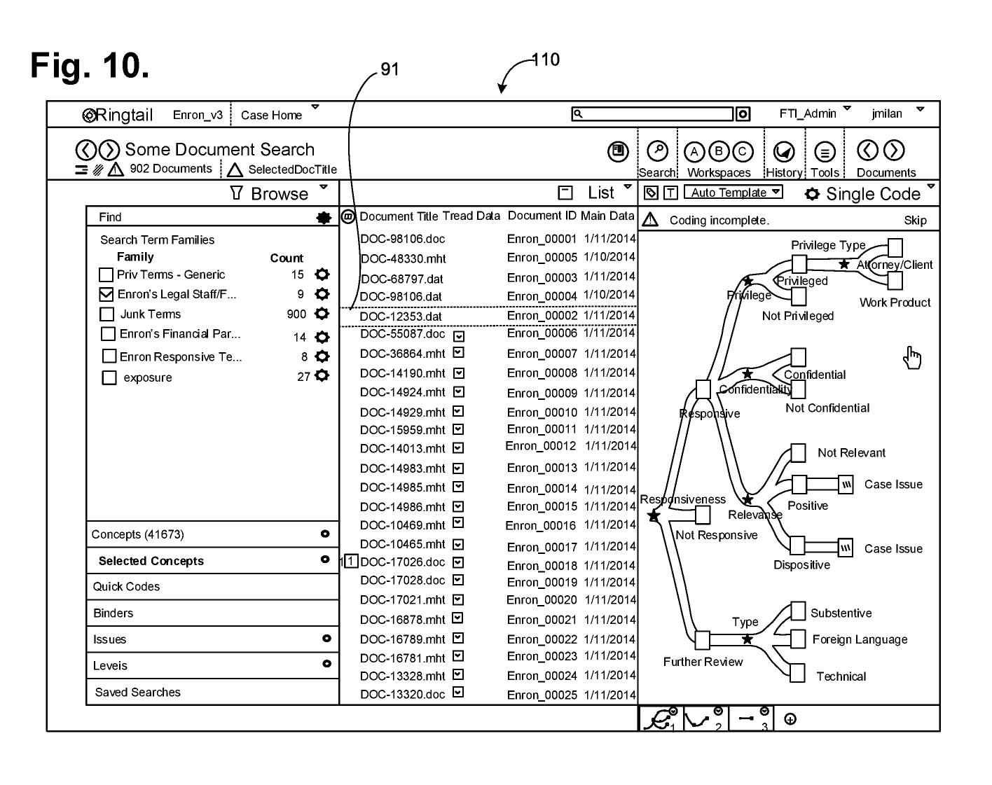

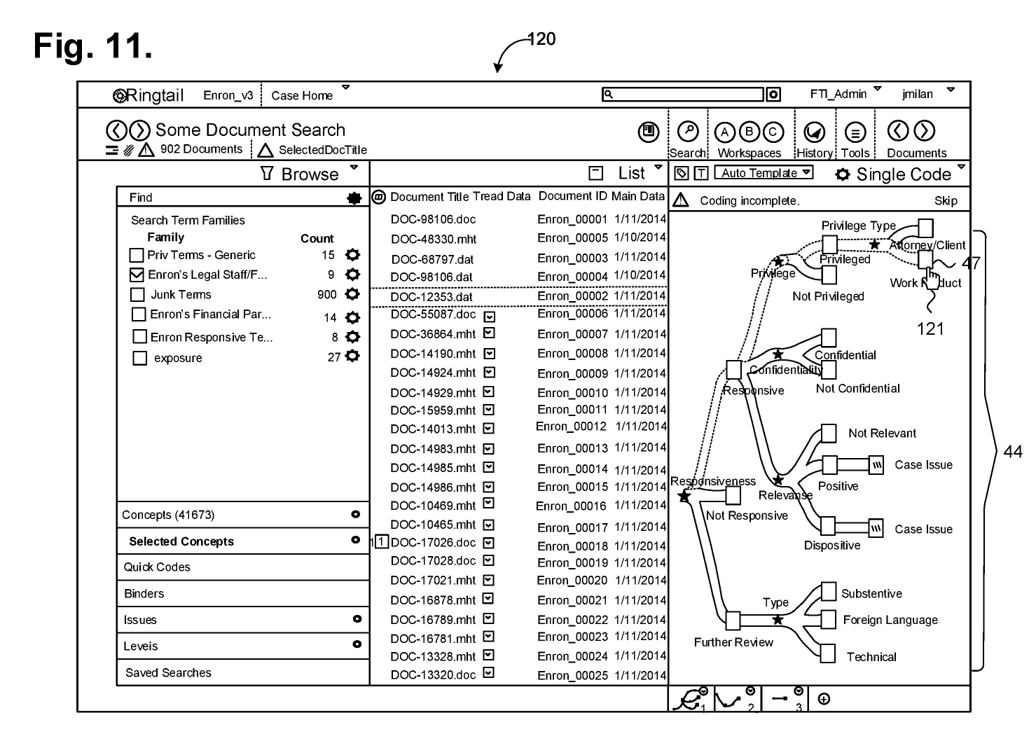

Once a highlighted document is coded, a new document can be selected for coding. FIG. 10 is a block diagram showing a screenshot of a webpage 110 with a new document 111 selected for coding. During review, the reviewer can make a provisional coding selection. FIG. 11 is a block diagram showing a screenshot of a webpage 120 showing provisional coding based on a selection within the conditional coding tree of FIG. 1. When the reviewer determines that the document falls under work product, the reviewer can hover his cursor 121, finger, or stylus over the selection box associated with the document code 47 for work product located in the coding tree 44. Automatically, the pathway in the tree that starts at responsiveness and ends at work product is highlighted with one color, such as yellow. As provided in FIG. 11, the yellow highlighted pathway is represented via dashed lines. Further, the document codes associated with the selected work product code are identified as belonging to that pathway.

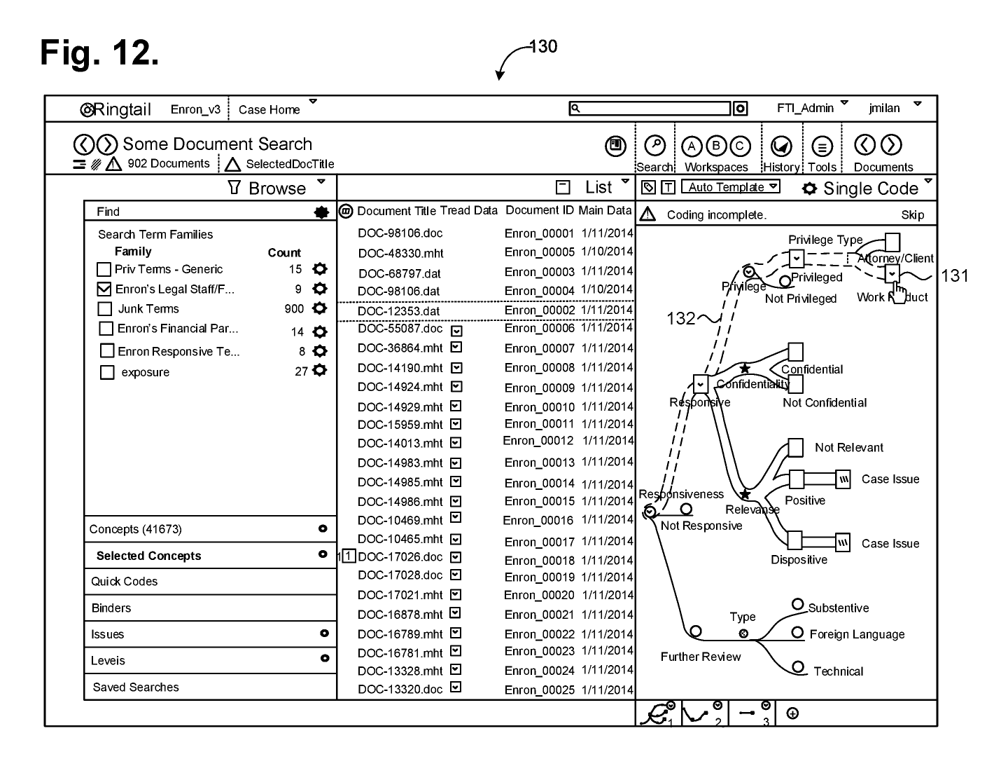

Once the reviewer determines whether the codes associated with the provisional coding selection are correct, the user can select all those codes by selecting the work product code. FIG. 12 is a block diagram showing a screenshot of a webpage 130 showing a final coding based on the provisional coding of FIG. 11. The reviewer can select 131 the box associated with work product, such as by clicking on the cursor within the box or tapping a finger on the box. Upon selection, the path associated with the work product document code is highlighted 132 a different color, such as blue, to indicate a coding selection. In FIG. 12, the blue highlighted pathway is represented by longer dashed lines than the yellow highlight provided in FIG. 11. All the boxes for codes located along the highlighted path are checked as selected codes for assigning to the document.

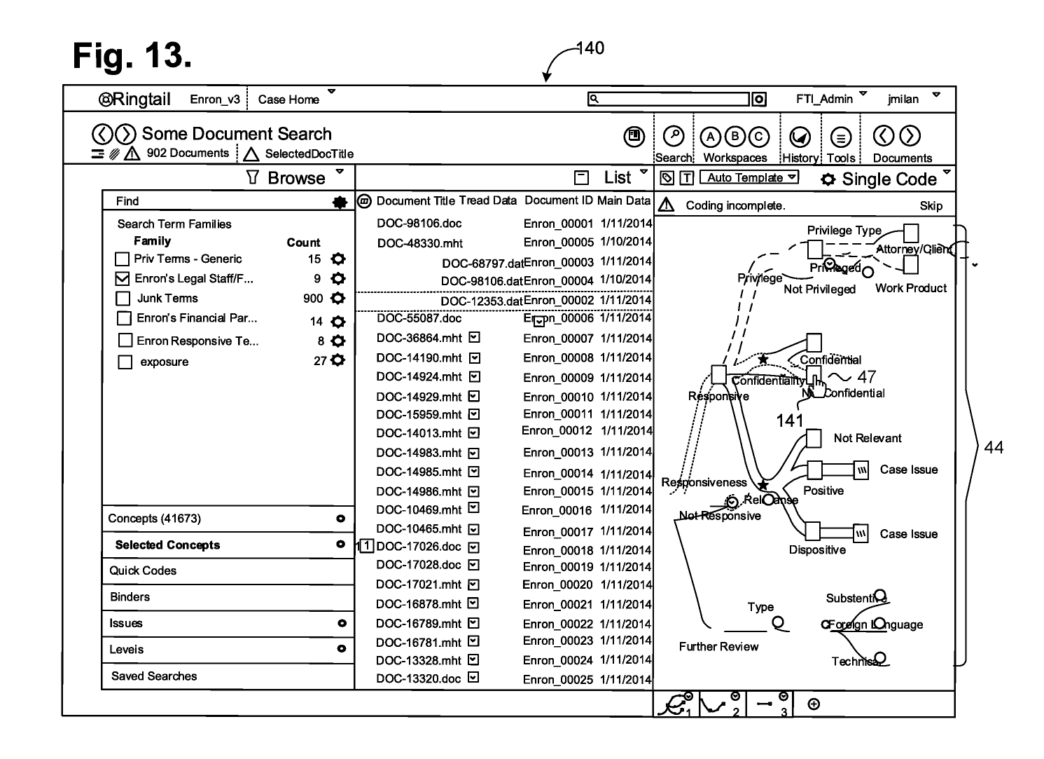

Upon further review of the document, the reviewer also believes that the highlighted document is also non-confidential. FIG. 13 is a block diagram showing a screenshot of a webpage 140 showing a further provisional coding for the new document of FIG. 10. The reviewer hovers his cursor 141, finger, stylus over the box for the non-confidential code 47 in the conditional tree 44 and the path from responsiveness to non-confidential is highlighted with a first color, such as yellow, to identify the potential coding. The first color highlight is represented by dashed lines in FIG. 13. Other types of highlighting are possible, such as making the lines bold, increasing a thickness of the lines, or filling in the lines. The reviewer can finalize the coding for the document by selecting or checking the box associated with the non-confidential coding 47.

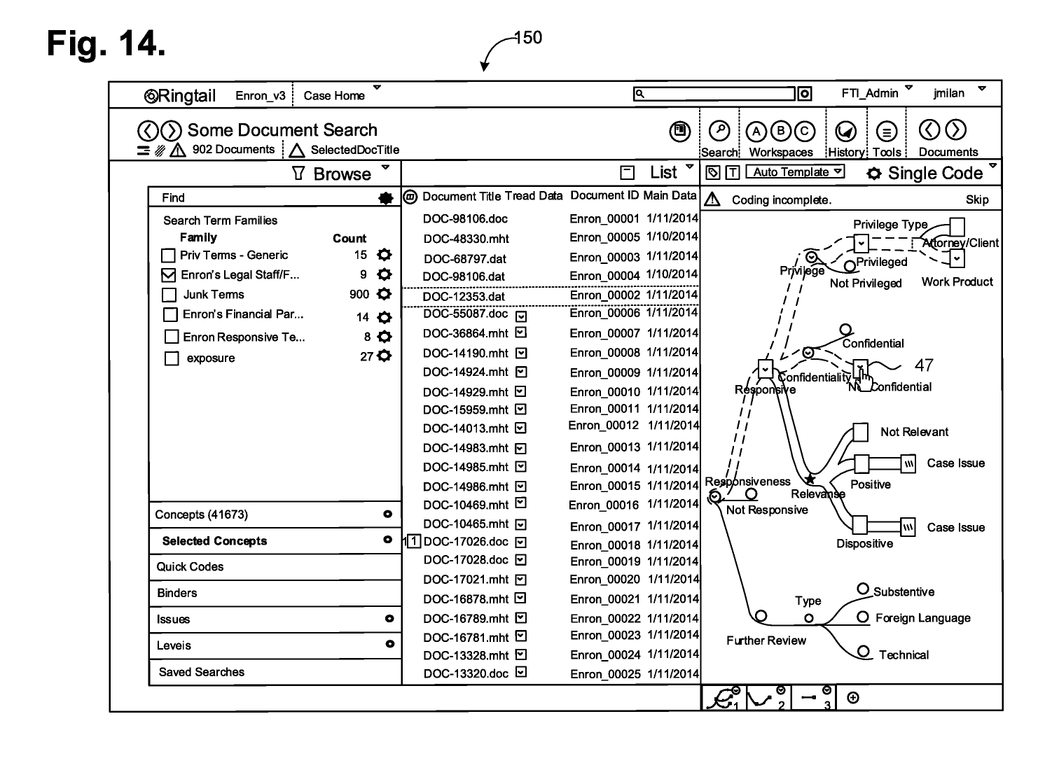

FIG. 14 is a block diagram showing a screenshot of a webpage 150 showing a final coding based on the provisional coding of FIG. 11 and the further provisional coding of FIG. 13. When the user selects the box for non-confidential coding 47, the highlighting of the path changes colors, such as to blue, to indicate the coding selections, and the boxes for the codes located along the path are checked as a representation that those codes are to be assigned to the document, along with the codes for responsive, privileged, and work product, as described above with respect to FIG. 12. In FIG. 14, the blue highlight is represented as longer dashed lines than the first color highlight in FIG. 13.

In one embodiment, if the selection of the non-confidential code is not consistent with any of the codes assigned previously, such as responsive, privileged, or work product, the reviewer may be unable to select the non-confidential code until the previously selected codes are removed. Alternatively, upon selection of the non-confidential code, the previously selected codes can be automatically removed if they are inconsistent with the new selection. In yet a further embodiment, an error message can be displayed informing the reviewer of the inconsistency.

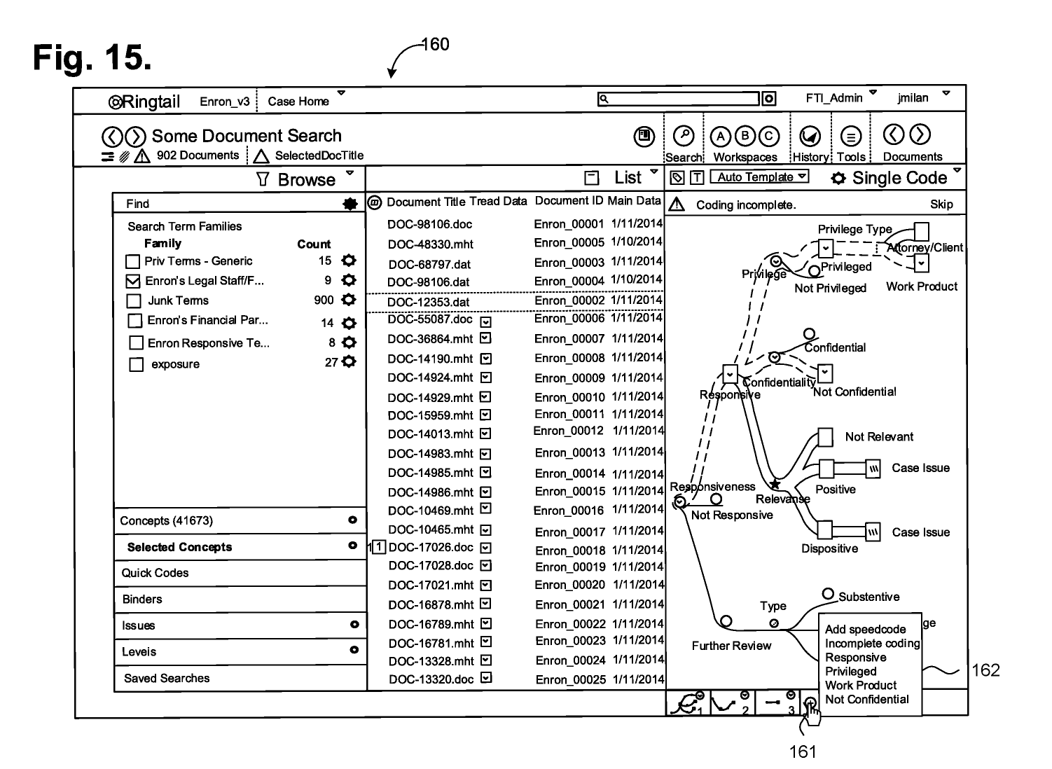

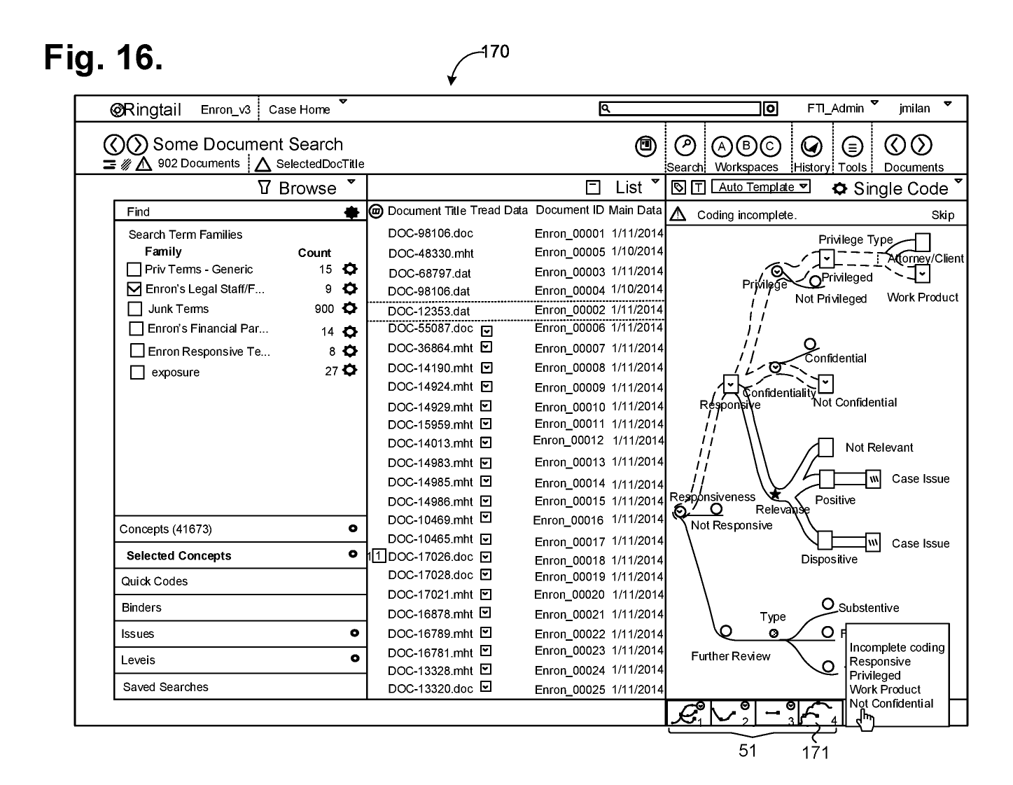

If a pattern for a pathway represented on the conditional tree is not represented by a mini-tree coding pattern, the reviewer or administrator can add that pathway by selecting a button, such as a button with an addition sign. FIG. 15 is a block diagram showing a screenshot of a webpage 160 with a button 161 for adding a mapping pattern for the final coding of FIG. 14. When the reviewer hovers his cursor, finger, or stylus over the addition sign button 161, the codes associated with the mapping displayed on the conditional tree can be displayed as a pop-up list 162, such as adjacent to the addition sign button 161. Once selected by the reviewer, the mapping displayed on the conditional tree is added as a new coding pattern. FIG. 16 is a block diagram showing a screenshot of a webpage 170 showing the mapped pattern of FIG. 15 with assigned document codings. The new coding pattern 171 can be displayed in the coding list 51 for use by the reviewer.

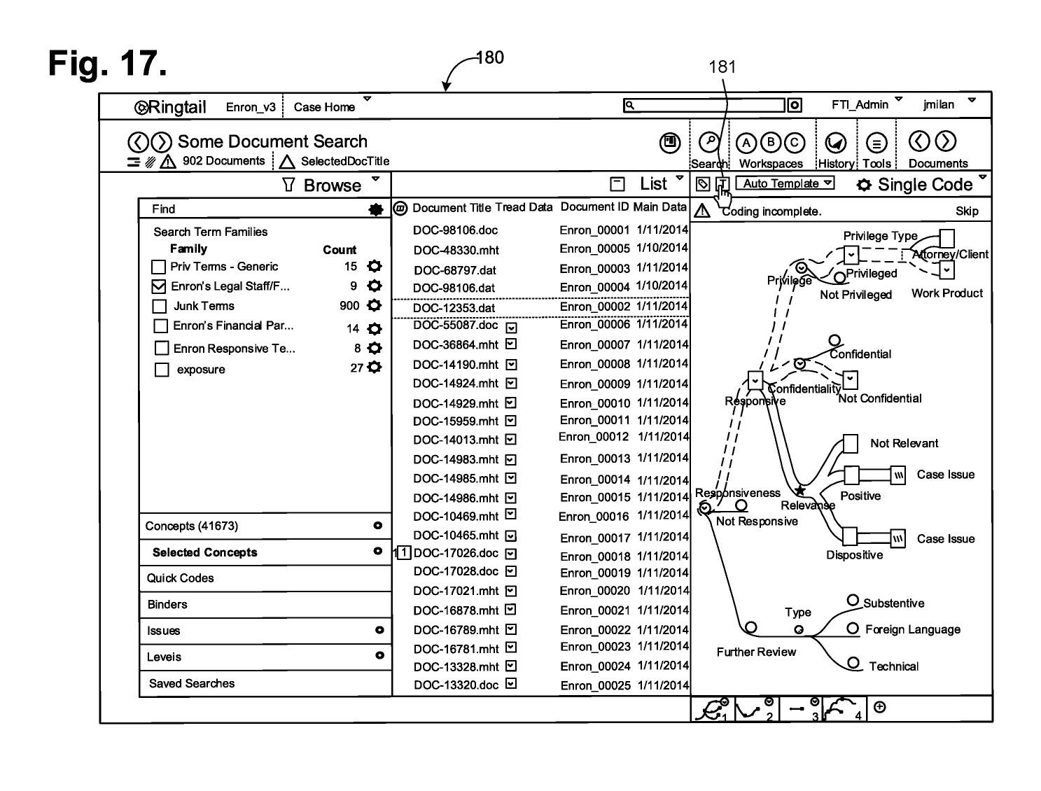

In a further embodiment, the pathways and codings can be represented as a list, rather than the conditional tree, but can follow the same rules as the conditional tree with respect to consistent codings and grouping of codings. For example, if work product is selected, the codes associated with work product include responsive and privileged. FIG. 17 is a block diagram showing a screenshot of a webpage 180 with a conditional list selection button. To access the coding list, the reviewer can select a list button 181 in the coding box 43, such as in a top left hand corner of the coding box.

Once selected, a list of headings or questions are provided in list form and each heading or question is associated with a drop down box, which includes document codes. FIG. 18 is a block diagram showing a screenshot of a webpage 190 showing a list of document codings based on the conditional tree of FIG. 1. For example, a heading list 191 can include responsiveness, privilege, privilege type, privilege log, confidentiality, and relevance. A list of document codes for each heading are provided in a drop down box 192. Upon selection of a document code within the drop down box 192 for one of the headings, the associated document codes can also be automatically selected for one or more of the remaining headings, if relevant. For instance, if the reviewer selects work product under the privilege type heading, the document code for privileged under the privilege heading and responsive under the responsiveness heading are automatically selected and displayed within the appropriate drop down boxes. The associated codes are identified based on the rules of the conditional tree and can be assigned to the document.

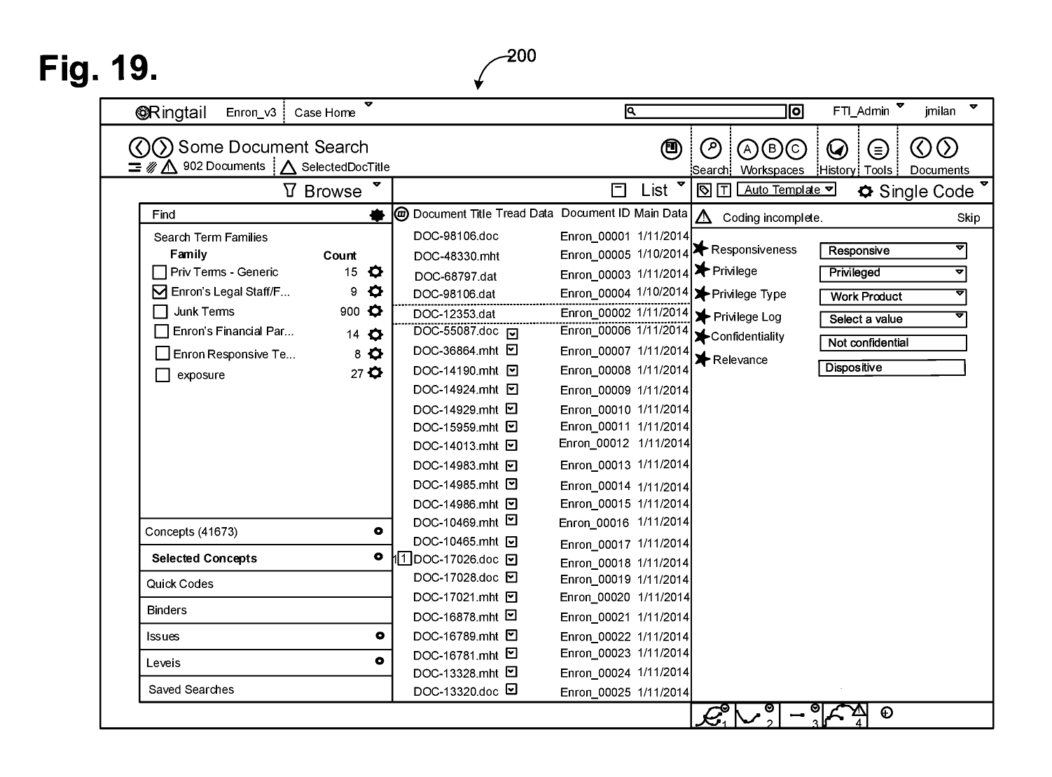

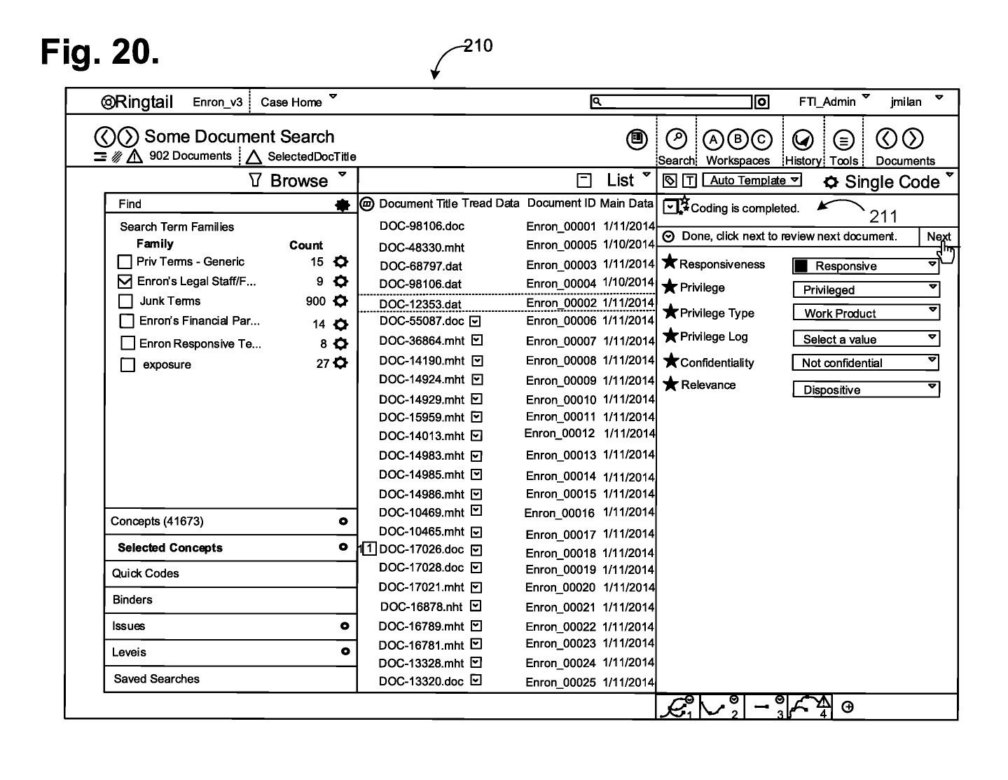

As in the conditional tree, the reviewer can select a document code that is located along a different path of the conditional tree, as long as the further code is not inconsistent with the previously assigned code. FIG. 19 is a block diagram showing a screenshot of a webpage 200 showing document coding via the list of FIG. 18. The reviewer selects the dispositive code under the relevance heading for assigning to the document, in addition to responsive, privileged, and work product. Once the reviewer is finished assigning codes, the coding for that document is complete. FIG. 20 is a block diagram showing a screenshot of a webpage 210 showing assignment of codes to a document using the list of FIG. 18. A notice 211 that coding of a current document has been completed is displayed and the reviewer can select a next button for accessing a further document for review.

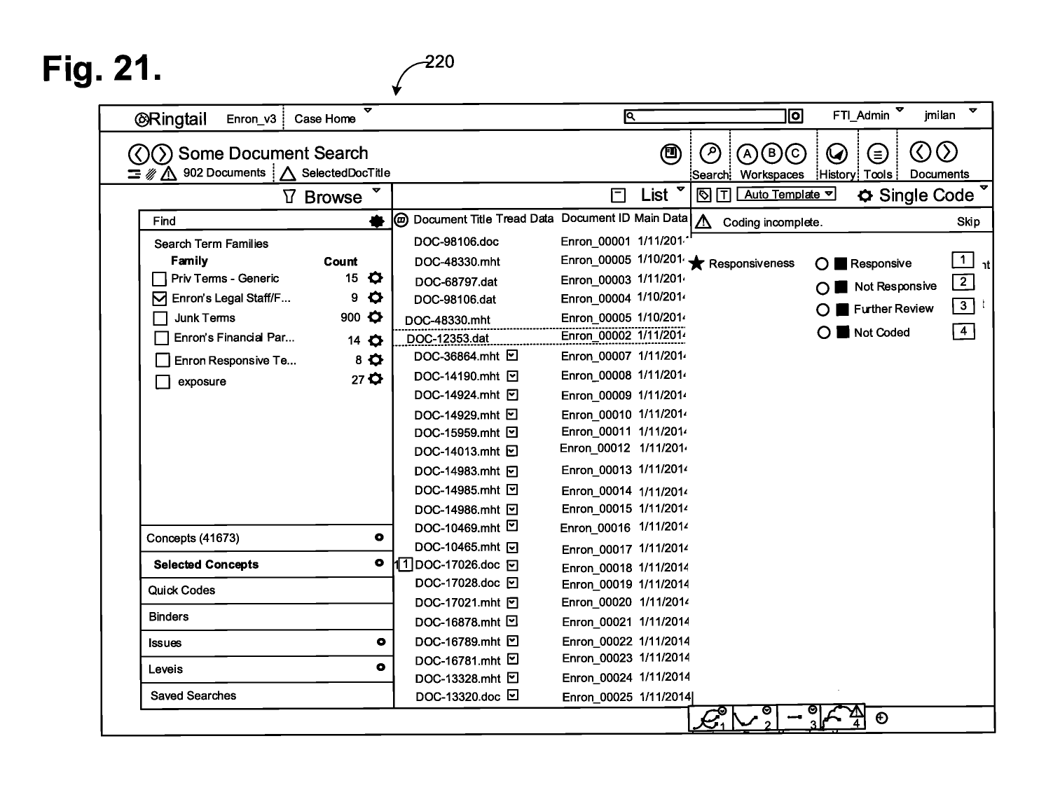

FIG. 21 is a block diagram showing a screenshot of a webpage 220 displaying a different list of codes for coding documents. In one embodiment, the list can include one or more headings and the codes associated with the heading. Further, a number of documents assigned each code can be displayed.

While the invention has been particularly shown and described as referenced to the embodiments thereof, those skilled in the art will understand that the foregoing and other changes in form and detail may be made therein without departing from the spirit and scope of the invention.

What is claimed is:

1. A system for document coding via coding patterns, comprising:
a database to store document codes;
a display; and
a server comprising a central processing unit, memory, an input port to receive the document codes, and an output port to provide the document codes to the display, wherein the central processing unit is configured to:
identify coding patterns from the document codes, each coding pattern comprising a grouping of two or more of the document codes;
receive for a document a selection of at least one of the document codes;
determine the coding pattern that includes the selected document code;
identify those document codes associated with the selected document code based on the determined coding patterns; and
assign the selected document code and the associated document codes to the document.

2. A system according to claim 1, wherein the display presents the document codes via a coding tree.

3. A system according to claim 2, wherein the display presents the coding tree with the document codes and headings for categories of the document codes and further presents pathways in the coding tree, each pathway starting at one of the headings and ending at one or more of the document codes.

4. A system according to claim 3, wherein the display presents at least one of the coding patterns as a mini-tree representing one or more of the pathways from the coding tree.

5. A system according to claim 4, wherein the selection of at least one of the document codes comprises a selection of one of the mini-trees.

6. A system according to claim 3, wherein the display presents at least one of the coding patterns by highlighting a pathway associated with that coding pattern in the coding tree.

7. A system according to claim 6, wherein the selection of at least one of the document codes occurs within the coding tree.

8. A system according to claim 1, wherein the central processing unit receives one or more of the coding patterns from a reviewer for display in a list.

9. A system according to claim 8, wherein the central processing unit generates a new coding pattern and adds the coding pattern to the list of coding patterns.

10. A system according to claim 1, wherein the display displays the document codes via a list comprising headings for the document codes and further displays the associated document codes in the list upon receiving the selection of the at least one document code for the document.

11. A method for system for document coding via coding patterns, comprising:
maintaining document codes;
identifying coding patterns from the document codes, each coding pattern comprising a grouping of two or more of the document codes;
receiving for a document a selection of at least one of the document codes;
determining the coding pattern that includes the selected document code;
identifying those document codes associated with the selected document code based on the determined coding pattern; and
assigning the selected document code and the associated document codes to the document.

12. A method according to claim 11, further comprising:
displaying the document codes via a coding tree.

13. A method according to claim 12, further comprising:
presenting the coding tree with the document codes and headings for categories of the document codes; and
presenting pathways in the coding tree, each pathway starting at one of the headings and ending at one or more of the document codes.

14. A method according to claim 13, further comprising:
displaying at least one of the coding patterns as a mini-tree comprising one or more of the pathways from the coding tree.

15. A method according to claim 14, wherein the selection of at least one of the document codes comprises a selection of one of the mini-trees.

16. A method according to claim 13, further comprising:
displaying at least one of the coding patterns by highlighting a pathway associated with that coding pattern in the coding tree.

17. A method according to claim 16, wherein the selection of at least one of the document codes occurs within the coding tree.

18. A method according to claim 11, further comprising:
receiving one or more of the coding patterns from a reviewer for display in a list.

19. A method according to claim 18, further comprising:
generating a new coding pattern; and
adding the coding pattern to the list of coding patterns.

20. A method according to claim 11, further comprising:
displaying the document codes via a list comprising headings for the document codes; and
upon receiving a selection of the at least one document code for the document, displaying the associated document codes in the list.
